(19) United States
(12) Patent Application Publication
(10) Pub. No.: US 2010/0014696 A1
(43) Pub. Date: Jan. 21, 2010

(54) HEARING DEVICE

(75) Inventors: Peter Boschung, Schmitten (CH); Martin Luetzen, Murten (CH); Erdal Karamuk, Meilan (CH); Gerard Van Oerle, Uster (CH); Hannes Oberdanner, Wolfhausen (CH); Hans Hessel, Benglen (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/524,206

(22) PCT Filed: Jan. 30, 2007
(86) PCT No.: PCT/EP07/50876

§ 371 Date: Jul. 23, 2009

(51) Int. Cl. H04R 25/00

(52) U.S. Cl. 381/328; 381/322; 381/330

(57) ABSTRACT

In of for a hearing device (2) acoustical attenuation within an acoustically effective channel (1) is controllably varied due to controlled variation of at least one of oscillating behaviour ( Z̅), elasticity (∈) and shape of a member (9) within the channel (1).

The present invention departs from hearing protection needs of growing importance for musicians.

In spite of the fact that the present invention has been initiated by hearing protection needs of musicians, equal or at least very similar needs may be encountered for users exposed to acoustical sceneries similar to sceneries experienced by musicians, so that the respective inventive solutions may also be applied for such other users.

Technical solutions as of the present invention initiated by accurate analysis of musicians' needs are considered of much broader applicability than just for hearing protection devices, namely for hearing devices generically.

We understand under the generic term of “hearing device” a device which is worn adjacent to or in an individual's ear with the object to improve an individual's acoustical perception. Such improvement may well be barring acoustical signals from being perceived in the sense of hearing protection for the individual user. If the hearing device is tailored so as to improve the perception of a hearing impaired individual user towards hearing perception of a “standard” individual, then we speak of a hearing aid device.

With respect to the application area a hearing device may be applied at least with a part thereof behind the ear, may be applied in the ear or even completely in the ear canal or may, at least in part, be implanted.

Musicians and especially musicians being members of performing groups as of brass bands, jazz bands, pop bands, symphonic orchestras, are often subjected to high sound pressure loading. This leads to the fact, as today recognized, that more and more frequently such individuals suffer from hearing damages. This is additionally amplified by the fact that today's audiences are becoming more and more de-sensitized with respect to acoustical volume perception, which leads to the tendency that orchestras perform increasingly loud. The social and economic damages which are caused by entire groups of population being hearing-impaired already at relatively young ages are tremendous.

It is thus a starting point of the present invention to provide hearing protection devices which are suited to remedy the addressed problem.

When we specifically speak of “hearing protection” we address dampening sound pressure level from the surrounding of an individual with respect to transmission into the area of individual's ear drum. We speak throughout the present disclosure, when addressing such dampening, from “attenuating sound pressure”. It has to be noted that hearing diseases which result from being exposed to respective high power acoustical signals for respective exposure times are, physiologically, mostly of mechanical nature, i.e. overload result at the inner ear structures caused by too high sound pressure.

A hearing protection device for wide spread acceptance as for the addressed group of population, but also for other similarly exposed population groups, should be of relatively simple technique and, nevertheless, accurate and reliable. The respective devices should be economically affordable for large groups of population including young people as e.g. music students.

There exist highly sophisticated electronic hearing devices e.g. of the type of hearing aid devices, which could be conceived to provide for dynamic hearing protection e.g. by controllably and dynamically adjusting the electronically realized transfer characteristic between an input acoustical/electrical converter and an output electrical/mechanical converter of such devices, e.g. as a result of automatic analysis of user's acoustical surrounding. Such devices are too expensive, too complicated, too support-demanding and not robust enough to find wide spread acceptance by the addressed group of population. Additionally such devices may mostly not provide for the high sound perception quality which e.g. musicians demand for.

Dynamic controllability of sound pressure attenuation is needed because in one moment of performance the surrounding of a musician presents a too high acoustical loading, in other moments, the addressed musician should accompany another musician of an orchestra playing in pianissimo, which other musician might be located, as in a large symphony orchestra, remotely. Therefore, dynamic variability of sound pressure attenuation should be realized in a non-expensive and robust technique, adding to the user as few acoustical artefacts caused by the hearing protection as possible.

The U.S. Pat. No. 3,918,550 teaches to provide along an acoustic connection tube of a behind-the-ear—BTE—hearing device an adapter piece. By means of a manually operable screw a vent, opening to the surrounding atmosphere, may be controllably opened and closed.

From the U.S. Pat. No. 6,549,635 it is known to provide within the ventilation channel of an otoplastic of a BTE or at an in-the-ear—ITE—hearing aid, a rigid valve element for adjusting the open cross-sectional area thereof.

From the U.S. Pat. No. 4,974,606 a hearing protection device is known which has two parallel acoustical channels extending between an area adjacent to the user's ear drum to the surrounding free space. In one channel there is provided a valve to adjust a desired dampening along the addressed one channel, whereas the second channel is either used as a measuring channel with tapped on measurement equipment or is sealingly closed in normal use.

From the EP 1 527 761 there is known an ear plug with an acoustic channel leading from a surface of the addressed plug exposed, when worn by a user, to user's surrounding and leading towards and adjacent to the ear drum area of the user. Within the channel there is provided an acoustic valve. The valve comprises a valve seat and a valve member, whereby the valve seat comprises a body of microchannels. The valve member comprises a flexible foil. The flexible foil thereby blocks direct sound transmission which in open position of the valve member bypasses the member and penetrates through the body of microchannels. In closed valve position the flexible foil blocks the direct sound transmission. Sound pressure transmission is controlled by opening or closing the valve, i.e. freeing or covering the microchannels.

It is an object of the present invention to provide a hearing device wherein attenuation of sound pressure of an acoustically effective hollow space, named an acoustical channel, may be controllably set without introducing acoustical artefacts during transients of controlling, being robust, accurate and of relatively simple technique. This is achieved by the hearing device according to the present invention which comprises at least one acoustically effective channel, a member with a controllably variable shape and/or with a controllably variable elasticity and/or with controllably variable oscillating behaviour in the open space of the at least one channel, sound pressure attenuation being directly controlled by said shape and/or elasticity and/or behaviour.

We understand under an acoustically effective channel of a hearing device most generically a hollow space which affects the transmission of acoustical signals from the surrounding of a user of the device into user's ear. Thus, under this generic aspect an acoustically effective channel of a hearing device may be a channel by which acoustical signals from the surrounding are fed to a subsequent acoustical-to-electrical input converter of the device, the output signal being signal processed so as to electrically feed an output electrical-to-mechanical converter of the device. Such channel may alternatively be a direct acoustical connection from the user's surrounding towards and onto the user's one ear drum or might be a venting channel e.g. along the outer surface of an otoplastic introduced into user's ear, be it an open channel bordered on one side by the user's ear canal wall or be it a closed channel embedded in a material of the otoplastic. It further may be a space within the hearing device which influences the overall acoustical behaviour of the hearing device as e.g. a back cavity of a microphone arrangement.

In opposition to known techniques, where, as e.g. known from the EP 1 527 761 discussed above, an acoustical valve in the acoustical channel is controllably opened or closed and thus sound pressure attenuation is directly varied by the effect of a moving member, according to the present invention the sound pressure attenuation is controllably varied directly by controlled variation of shape, elasticity and/or oscillating behaviour of the member within the acoustic channel.

We thereby understand under “oscillating behaviour” the transfer characteristic as defined by the quotient of downstream sound pressure to upstream sound pressure with respect to the addressed member and as a function of sound pressure frequency.

By the fact that the hearing device according to the present invention provides for the addressed member, the shape, elasticity and/or oscillating behaviour thereof being controllably variably, it becomes possible to controllably influence acoustical attenuation of such a channel or hollow space substantially without artefacts. The member may be realized in highly robust and simple technique nevertheless accurate in controlling sound pressure attenuation.

The device mentioned and of the present invention may also be a separate module which is attachable to a hearing device. If e.g. some of the users have respectively personalized hearing devices, as e.g. hearing aid devices, the device according to the present invention may be conceived attachable the acoustical input or output of such a hearing device. In other words, the device according to the present invention may be attached in front of the acoustical input of an acoustical/electrical input converter of the user's hearing device. Even if such personal hearing device is e.g. a sophisticated hearing aid device with digital signal processing ability and normally with a loudness limiter, the limiting effect thereof being possibly even adjustable by a remote control, e.g. due to reasons of standardizing controllability of overall attenuation, it might be advisable to perform attenuation control with a device as of the present invention plugged or attached upon such more sophisticated hearing device.

In one embodiment the hearing device or module according to the invention comprises a drive arrangement for controllably varying the addressed shape, elasticity and/or oscillation behaviour, whereby the drive arrangement comprises a piezoelectric drive and/or a pneumatic drive and/or a hydraulic drive and/or an electrostatic drive and/or a magnetic drive and/or an electroactive polymer drive.

We understand thereby under a “piezoelectric” drive a drive whereat controllability is realized by controllably varying a difference of electric potential, such difference resulting in deformation of a piezoelectric element. With respect to electroactive polymer drives attention is drawn e.g. on the article “electroactive polymers” in Wikipedia and e.g. on the products of Micromuscle AB, 58216 Linköping, Sweden. It must further be stated that the member itself which is controllably variable with respect to its elasticity, shape, oscillating behaviour may be formed integrally with a respective drive. As an example, a piezo electric drive may be provided and operationally connected to the addressed member as a separate device or such piezoelectric drive may directly incorporate the addressed member or even be realized by the addressed member with a shape which is controllably variable by the applied difference of electric potential.

The addressed drive principles for controllably varying or adjusting shape, elasticity or oscillating behaviour of the member do fulfil the requirements as outlined above as well.

In one embodiment of the hearing device according to the present invention the drive arrangement comprises at least one electroactive polymer actuator of the artificial muscle type. Thereby, high constructional flexibility at extremely small constructional volumes is reached.

As was addressed above the acoustical effective channel of the hearing device or module may be formed by any kind of partly or completely encapsulated space which acoustically influences the overall acoustical behaviour of the hearing device. It might even be such space which is formed between the outer surface of an otoplastic shell and the wall of a user's ear canal as e.g. a venting space.

In one embodiment the addressed channel is specifically an acoustic channel which is explicitly provided for leading sound pressure from the surrounding of the user towards his ear drum or is a venting channel of the device or module.

In one embodiment the hearing device or module is a hearing protection device or module, wherein the addressed channel is provided explicitly for leading sound pressure from the surrounding of the user towards his ear drum.

In one embodiment of such hearing protection device or module, according to the present invention, the addressed channel is conceived to be worn outside the ear canal of a user. This embodiment is especially suited for hearing protection devices of the BTE type, at which the addressed operational connection may be provided along the tubing between a unit of the device worn behind the ear and ear canal otoplastic. If in this embodiment, where the addressed channel is conceived to be worn outside the ear canal of a user, the device according to the invention is a module, such module may be interconnected between the part worn behind the ear and the part introduced into the ear canal of a BTE or may be applied upstream the arrangement of acoustical/electrical converters integrated in the part of the BTE, which is worn behind the ear. Here too, it might be seen that by the modular concept a large range of existing BTE may be retrofitted flexibly to become equipped with the device according to the present invention, exploiting the abilities thereof. Further, the approach of applying the device according to the present invention integrated into a BTE or as a module to a BTE allows to provide e.g. in a large symphony orchestra for the performing players, which frequently change, a hearing protection device being placed at disposal by the orchestra. This due to the fact that on one hand BTE devices do require much less efforts for adapting to the individual user than necessitated by ITE or even CIC type devices, so that one BTE device may easily be worn by more than one user. On the other hand, the fact that a device according to the invention as a module may easily be applied to an existing BTE makes standardized use of the device according to the invention for large groups of users even easier.

In another embodiment the addressed channel is conceived to be worn inside the ear channel of a user. This embodiment addresses especially hearing protection devices of the ITE or CIC types. These types of hearing protection devices are especially suited for users which own their personal, individual protection device.

If thereby the device according to the invention is a module, such a module may be plugged or applied upon an existing ITE or CIC hearing device. Thereby, the personalized characteristics of such ITE or CIC devices as with respect to the shape of the user's ear canal are maintained, and the device module as of the present invention is just plugged on such pre-personalized hearing device.

In one embodiment the member is at least one membrane. We thereby understand under a “membrane” a part which is substantially thinner in one dimension than it is extended in the two other dimensions of a Cartesian coordinate system. Such membrane may be plane or bent. If such membrane is very thin it may be said foil-like. On the other extreme, if such membrane is rather thick it approaches the structure of a plate-like part.

Thereby, it has been recognized that a membrane is a member highly suited to be controllably varied in shape and/or elasticity and/or behaviour of oscillation on the one hand and, on the other hand, is highly apt to take effect upon sound pressure attenuation. The shape of a membrane is variable as by controlled tensioning and release, be it by forces within the general plane of the membrane or perpendicularly thereto. Thereby elasticity may additionally be varied. Elasticity per se of a membrane may be controllably varied e.g. thermally or by squeezing stress or by radiation. Thus, the addressed membrane offers a huge variety of possibilities to controllable vary shape and/or elasticity and/or oscillating behaviour. Oscillating behaviour of a membrane per se may e.g. be controllably varied by respectively dampening its movability.

The membrane may be of a single material, e.g. of a plastic material or may be laminated including different materials as from metal, plastic material, dielectric material.

In spite of the fact that the addressed membrane might be provided to form a part of the wall of the channel or might be provided obstructing just a part of the free cross-sectional area of the addressed channel, in one embodiment the membrane completely covers an open cross-sectional area of the channel. Thereby, this shall not exclude that the membrane has one or a multitude of perforations to specifically tailor its acoustical impedance.

When providing the addressed membrane with perforations care should be taken not to provide too long or too much free edges at the membrane to avoid acoustical artefacts as by spurious resonances caused by uncontrolled oscillation of free edge areas.

In one embodiment the membrane is controllably adjustable by controllably varying its tension. Thereby, the tension of the membrane may controllably be varied in the plane of the membrane e.g. by controllably stretching and releasing the membrane or may be varied by controllably varying thickness of the membrane as by compressive stress leading to an expansion of the membrane in its plane. Tension of the membrane may further be varied by controlled bending or biasing.

In one embodiment the membrane is controllably adjustable by varying elasticity of the membrane material at least along a part of such membrane. Variation of such elasticity per se may e.g. be realized by radiation, e.g. ultraviolet radiation or by heating or infrared radiation.

In one highly advantageous embodiment of the hearing device according to the present invention the member comprises at least a part of the wall of the channel. By providing along the addressed channel at least a part of its wall with a controllably variable shape and/or elasticity and/or oscillating behaviour, it becomes possible to control the sound pressure attenuation without any member substantially interfering with the sound pressure conducting open space of the channel.

When looking back on the above discussed approach comprising a membrane as the member it has to be noted that a part of the channel wall may be conceived as a membrane so as e.g. to realize controlled variation of shape of the channel wall. Then in fact what was said with an eye on providing a membrane as member prevails also for an embodiment as addressed here, where such membrane is part of the channel wall.

In one embodiment the wall of the channel is elastically stretchable and controlled variation of shape comprises controlled variation of the length extent of the channel.

In one embodiment the wall of the channel is elastically stretchable and controlled variation of shape comprises controlled variation of the open cross-sectional area of the channel.

The addressed hearing device or module may be controlled with respect to controllability of the member by remote control, wirebound or wirelessly or may be controlled by hearing device internal—or even module internal—analysis of the prevailing acoustical situation. The addressed technique is perfectly suited to be provided in or at a hearing device to provide for a hearing protection device which is construed in robust and relatively simple technique, thereby for individual use with relatively little support by specialized persons. Thereby, all these advantages make a respective hearing device or module perfectly suited as hearing protection device for larger groups of population, as for musicians.

The invention shall now further be described by means of examples and with the help of figures. The figures show:

FIG. 1 a generic signal flow/functional block diagram of a hearing device according to the present invention, wherein acoustical attenuation is controllably variable within an acoustically effective hollow space of the device;

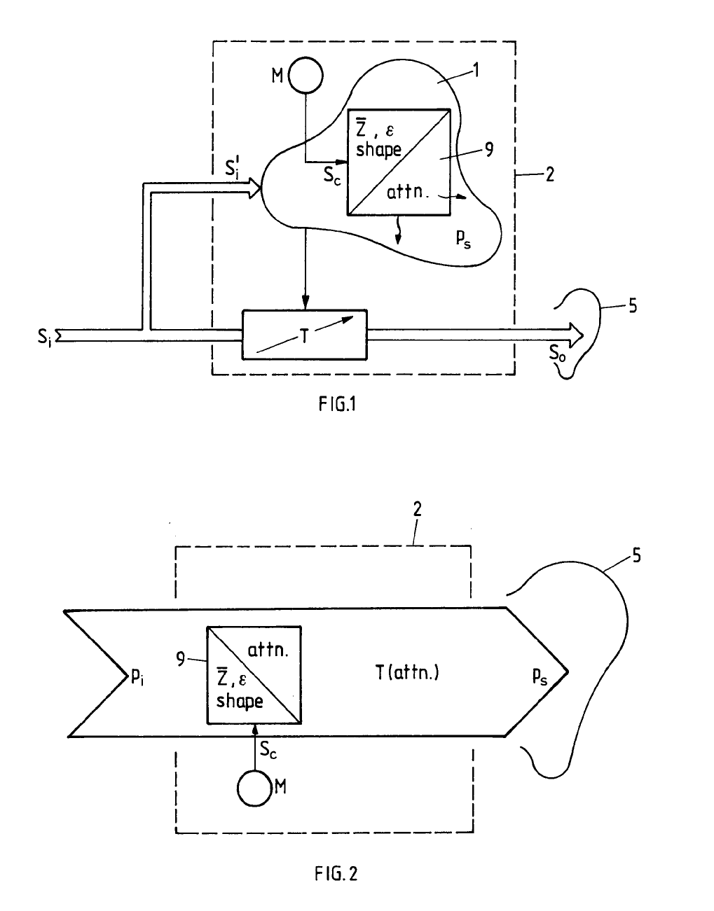

FIG. 2 in a representation in analogy to that of FIG. 1, a device wherein the attenuation is controllably variable along an acoustical channel which is provided with the purpose of leading acoustical sound pressure from a user's surrounding towards and onto an area within user's ear;

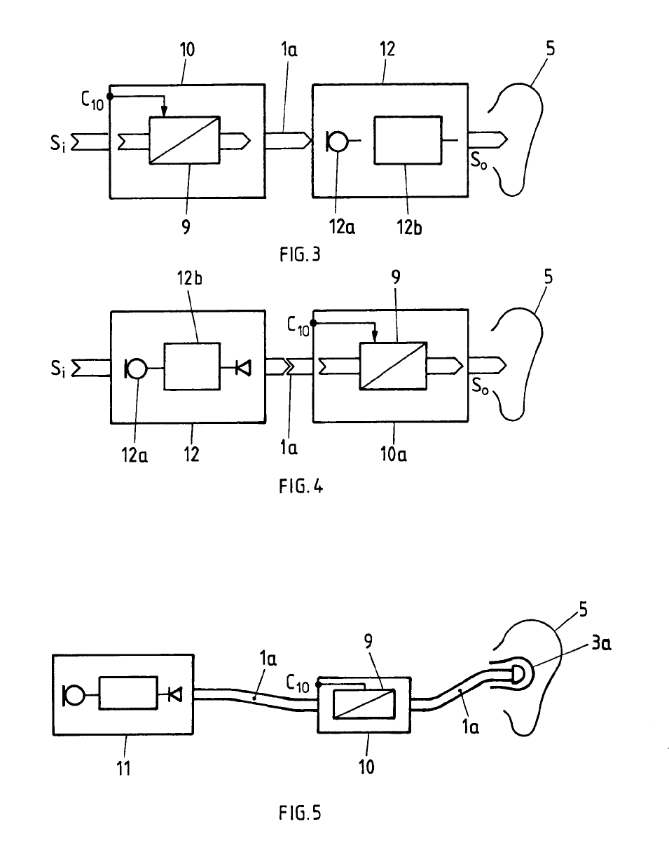

FIG. 3 in a schematic signal flow/functional block diagrammatic form, a first modular concept of a device according to the present invention;

FIG. 4 in a representation in analogy to that of FIG. 3, a second modular concept of the device according to the invention;

FIG. 5 in a schematic and simplified representation, an outside-the-ear hearing device according to the present invention with sound pressure attenuation ability outside a user's ear;

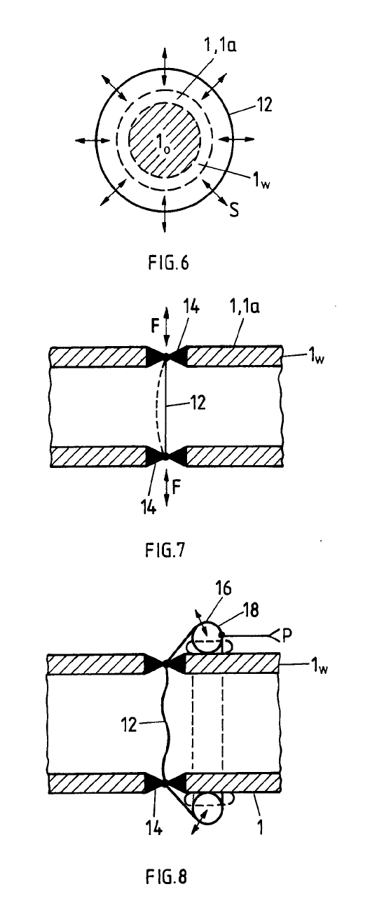

FIG. 6 schematically, a membrane within an acoustical channel of a hearing device according to the present invention which is tensionable and releasable for controllably varying the acoustical attenuation;

FIG. 7 in a simplified sectional view of an acoustical channel of a hearing device according to the invention, with a controllably tensionable and releasable membrane;

FIG. 8 in a representation in analogy to that of FIG. 7, an embodiment of the arrangement of FIG. 7 with hydraulic or pneumatic drive;

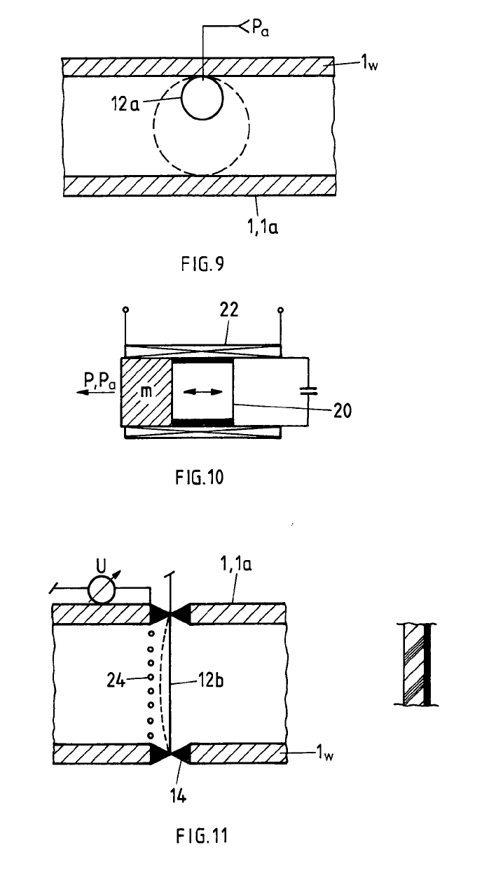

FIG. 9 in a simplified sectional representation, a further embodiment of controllably varyiable acoustical attenuation along an acoustical channel in a hearing device according to the present invention;

FIG. 10 in a sectional and simplified representation, an electromagnetically driven pressurizing source as a pressurizing drive provided in the embodiments according to the FIG. 8 or 9;

FIG. 11 again in a simplified sectional representation, a further embodiment of an acoustical channel, whereat attenuation is controllably variable, driven by an electrostatic drive;

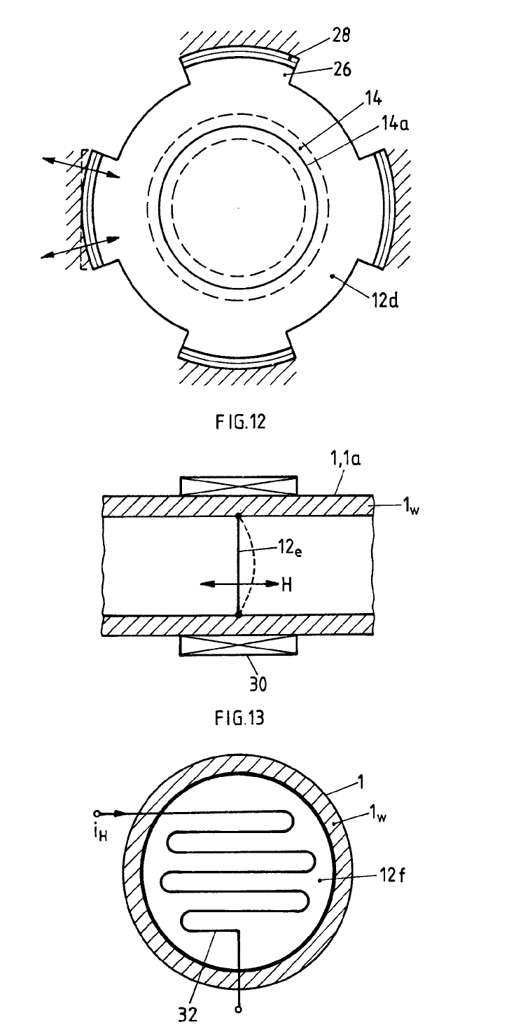

FIG. 12 again in a simplified sectional representation, a membrane as applied for controllably varying attenuation in an acoustical channel of a device according to the present invention, operated by a piezoelectric drive;

FIG. 13 in a simplified cross-sectional representation, an acoustic channel in a device according to the present invention with electromagnetically driven membrane or with electromagnetically damped membrane;

FIG. 14 in a simplified representation, a membrane in an acoustical channel of a device according to the present invention, the elasticity thereof being thermally controllably variable;

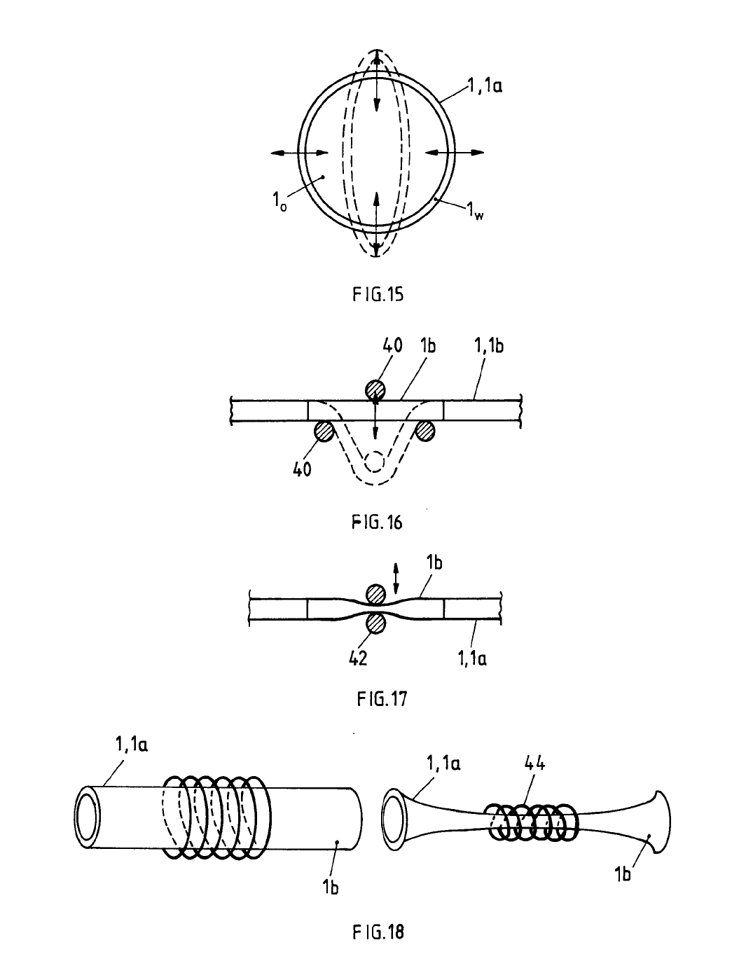

FIG. 15 most generically, an acoustical channel in a hearing device according to the present invention, the wall of which being controllably acted upon to controllably vary acoustical attenuation therein;

FIG. 16 in a simplified representation, an embodiment realizing the principle as of FIG. 15;

FIG. 17 a further embodiment realizing the principle as of FIG. 15;

FIG. 18 in a simplified perspectivic representation the principle as of FIG. 15, whereat the open cross-sectional area of the channel is controllably varied by a means of an artificial muscle actuator, and

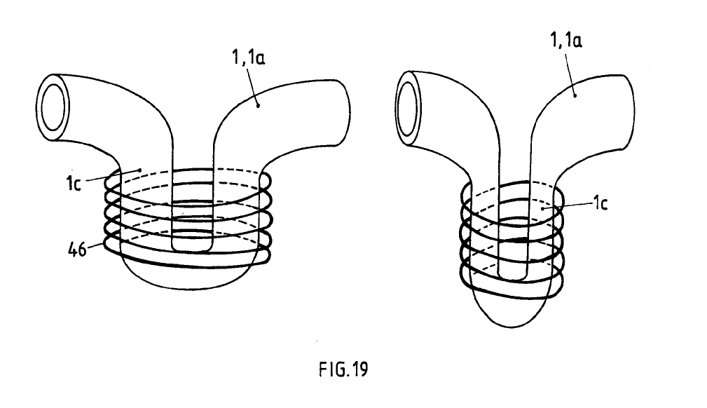

FIG. 19 a further embodiment realizing the principle as of FIG. 15 by means of an artificial muscle actuator.

FIG. 1 shows, by means of a generic signal flow/functional block diagram, the principal approach according to the present invention for controllably attenuating sound pressure in an acoustical channel 1 of a hearing device 2, the acoustical behaviour of channel or chamber 1 influencing the transmission T of acoustical signals Sᵢ through the device 2 towards perception by a user 5 of an output mechanical signal Sₒ of the device 2.

In acoustic channel 1 there is provided a converter member 9. The shape and/or elasticity ∈ and/or oscillating behaviour Z̅ of the member 9 is or are controllably variable by a controlling signal S_{c}. The member 9 acts as a shape-to-attenuation and/or elasticity-to-attenuation and/or oscillation behaviour-to-attenuation converter.

According to the most generic representation of the present invention in FIG. 1, by means of converter member 9 the attenuation of sound pressure pₛ in chamber or channel 1 is varied. Sound pressure pₛ is thereby generated within chamber or channel 1 in dependency of the acoustical signal Sᵢ as impinging on the hearing device 2. Sound pressure attenuation in chamber or channel 1 which is varied by means of converter member 9 influences the overall transmission T of acoustical signal Sᵢ impinging upon the hearing device 2 converted and transmitted towards the ear drum of individual 5 as a mechanical output signal Sₒ.

Thus, by controllably varying the oscillating behaviour Z̅ of converter member 9 the acoustical attenuation in channel or chamber 1 is controllably varied. Alternatively or additionally, controllably varying the elasticity ∈ of member 9 results in an accordingly controlled variation of the acoustical attenuation in channel 1. Again alternatively or additionally, controlled variation of the shape of the member 9 results in an accordingly controlled variation of the attenuation in channel 1. As is perfectly clear to the skilled artisan, controllably varying the shape of member 1 may vary the elasticity as well as the oscillating behaviour of the member. Controlled variation of the elasticity may vary the oscillating behaviour as well as the shape of the member, etc., i.e. the addressed three parameters, namely shape, elasticity and oscillating behaviour, may or may not be varied independently.

As addressed by the representation in FIG. 1 the converter member 9 is located and becomes effective in the hollow space of acoustical channel or chamber 1.

The controlling signal S_{c} which causes at member 9 a respective variation of oscillating behaviour and/or elasticity and/or shape is generically generated by a drive M. As represented in FIG. 1 the drive M may thereby be realized remote from the member 9 and thus of the acoustical channel or chamber 1, or may be (not shown) realized integral with member 9 or may even be realized by the member 9 itself. Two simple examples shall make these considerations clear:

If the shape of a member 9 is controllably varied by an external pressure, then a pressurizing source will be realized as the drive M remote from the member 9. On the other hand, if the shape of the member 9 is controllably varied by exploiting piezoelectric effect, then a difference of electric potential will be applied to the member 9 consisting at least in part of piezoelectric material so that the member 9 itself will act as drive for controllably changing its proper shape.

According to FIG. 2 the chamber or channel 1 of FIG. 1 is realized as an acoustical channel 1a of device 2 which has the purpose to transmit input acoustical sound pressure pᵢ from the surrounding of the user 5 into the ear of the user. The acoustical attenuation as discussed in context with FIG. 1 here directly affects sound pressure as transmitted by the transmission T to the ear of the user 5. The converter member 9 is part of the overall transmission T of the device 2. Thus, by accordingly controllably varying the addressed attenuation, dynamic hearing protection is achieved at a hearing device 2.

Such channel 1a of a hearing device may be called “main transmission channel”.

With an eye on the representation according to FIG. 2 it becomes evident that the converter member 9 may in fact be provided in series along the signal path from the acoustical signal impinging from the user's surrounding up to the signal applied in individual's ear. Thus, such converter member 9 may be a part of a hearing device or may be a module which is attached upstream or downstream an existing hearing device, be it a BTE, a ITE or a CIC hearing device which intrinsically is possibly conceived as a hearing aid device with respectively sophisticated signal processing. In FIG. 4 there is schematically shown a first embodiment of such modular concept, in which a modular unit 10 with the converter member 9 is arranged and attached upstream a hearing device 12 having e.g. and as shown in FIG. 4, an input acoustical/electrical converter arrangement 12a operationally connected to a digital signal processing unit 12b, which latter is operationally connected (not shown in FIG. 4) to an output electrical/mechanical converter so as to generate the output signal Sₒ towards the ear of the user 5. The interconnection between the output of module 10 and the acoustical input of hearing device 12 is realized via an air space.

Inversely, FIG. 5 shows an embodiment where the modular unit 10a is attached to a hearing device 12, e.g. again a more sophisticated hearing aid device, at the output side of the device. In the representations of the FIGS. 4 and 5 the drives as have been described in context with FIGS. 1 and 2 for operating converter member 9 are not shown, but controllability of these members 9 is addressed schematically by the control input C₁₀.

Principally, both modular concepts as of FIGS. 4 and 5 may be realized for all three types of hearing devices 12, BTE, ITE and CIC, whereby the concept according to FIG. 4 is probably more suited for the ITE and especially for the CIC types.

As a further example, according to FIG. 5 the converter member 9 interacts with the main transmission channel 1a outside the ear channel 3a and is e.g. applied along a tube interconnecting an outside-the-ear unit 11 with ear canal 3 of a user 5.

Such conception of a hearing protection device according to the present invention has the advantages that one and the same device may be worn by different users as it does not require substantive adaptation to the ear canal shape of respective users and on the other hand, that the constructional volume, a unit with the converter member 9, is not limited by the volume of the ear canal 3a.

A first embodiment of a converter member 9 is a membrane 12 according to FIG. 6. Heuristically and without entering more complex considerations of the effects of membranes within an acoustical channel with respect to acoustical impedance, one may say that a membrane which loosely covers at least a predominant part of the open cross-sectional area of an acoustical channel provides for less sound pressure attenuation than such membrane which is tightly spanned across the addressed part of the open cross-sectional area of the channel. Thus and as schematically shown in FIG. 6 a first embodiment of realizing converter member 9 is a membrane 12 covering for instance and as shown in FIG. 6 completely the open cross-sectional area 1ₒ of the channel 1, 1a having a wall 1_{w}. By variably stressing the membrane 12 of elastic material across the area 1ₒ, as schematically indicated by the double arrows s, the membrane 12 is variably tensioned and released like a drum head across the open space 1ₒ.

According to FIG. 7 the membrane 12 is mounted via spring elements 14 e.g. of rubber-like material to the wall 1_{w} of the channel 1, 1a and is tensioned and released in a controlled manner by applying, externally with respect to the channel 1, 1a forces F. Thereby on one hand the membrane 12 is varied in shape and the drive providing for the forces F, M of FIG. 2, may be located outside the acoustical channel 1, 1a.

In FIG. 8 there is schematically shown an embodiment according to FIG. 7, where the elastic membrane 12 is controllably tensioned and released by a pneumatic or hydraulic drive. The membrane 12 e.g. of a plastic material is mounted via the spring elements 14 to the relatively rigid wall 1_{w} of the channel 1, 1a. The membrane 12 overlaps this mount towards the exterior of the channel 1, 1a. The rim portion 16 of the overlapping part of membrane 12 is fixed e.g. welded to an elastically expandable and collapsible drive tube 18 which extends around the wall 1_{w} of the channel 1, 1a. The tube 18 e.g. of a plastic material is connected to a controlling pressurizing source P for a pressurizing gas or a pressurizing liquid. By controllably varying pressurizing the interior of tube 18 the membrane 12 is accordingly controllably tensioned and released.

In the embodiment according to FIG. 9 the membrane 12a is tailored as an elastically expandable and collapsible bag within the acoustic channel 1, 1a. By means of a pressurizing source Pₐ a gaseous or a liquid pressurizing medium is fed to the ball-shaped membrane 12a. Thereby, as shown in dashed line, the bag is e.g. expanded up to fully close the channel 1, 1a. Especially if the membrane 12a is pressurized with a liquid pressurizing medium from source Pₐ, a highly effective attenuation of sound pressure is reached.

For generating the pressure P, Pₐ of FIGS. 8, 9 e.g. an electro-magnetically driven piston arrangement may be used as shown in FIG. 10. A plunger 20 of ferromagnetic material is sealingly driven electro-magnetically, as by a coil arrangement 22, to bias pressurizing medium m towards and into ball-shaped membrane 12a or tube member 18 of FIGS. 9 and 8 respectively.

In the embodiment of FIG. 10 the converter member 9 of FIG. 1 or 2 is a membrane 12b of elastic foil which is, as shown at the right hand of FIG. 11 in enlarged form, metallized along one of its extended surfaces. In the channel 1, 1a there is provided a metallic grid distant from membrane 12b. By means of a voltage source U there is applied between grid 24 and the metal layer on membrane 12_{b} a difference of electric potential by which, as shown in dashed lines, the membrane is biased towards grid 24. When the membrane 12_{b} is relatively loose in the position as drawn in FIG. 11 in solid line, it becomes tensioned when biased towards grid 24. So as to prevent acoustical artefacts the membrane 12b at most gently touches grid 24. In a further embodiment, shown in FIG. 12 schematically, the converter member 9 of FIG. 1 or 2 is realized by a membrane 12d mounted e.g. as shown in FIG. 7. A welding seam is shown at 14a. Segments 26 of the membrane 12d overlap outwardly the spring members 14 and are fixed to actuators 28 which e.g. and as shown with a double-arrow in FIG. 12, may controllably be bent in synchronism. Such actuators may be based on piezoelectric effect as e.g. Bimorphs or may be construed based on bi-metal principle. Further known physical effects might be applied for variably tensioning the membrane 12d as e.g. magnetostrictive effects.

In the embodiment of FIG. 13 a metallic membrane 12e e.g. of an electro-conductive plastic material is peripherally mounted to the wall 1_{w} of the channel 1, 1a rigidly. By means of a coil arrangement 30 adjacent to the magnetically permeable wall 1_{w} of the channel 1, 1a a magnetic field H is generated within the channel 1, 1a penetrating the membrane 12e. By respectively controlling the strength of the magnetic field H the oscillation of the membrane 12e may be variably attenuated. Realizing membrane 12e of ferromagnetic plastic material allows to magnetically tension and release membrane 12e as shown in dash line in FIG. 13.

In the embodiment of FIG. 14 the membrane 12f is mounted to the inside of wall 1_{w} of channel 1, 1a. On at least one side of the membrane 12f which is e.g. of a plastic material, there is applied a heating meander 32. By applying a controlled heating current i_{H} to the heating meander 32 the membrane 12f which has a small thermical mass is heated up reducing its elasticity and thereby reducing sound pressure attenuation there through.

Instead of providing heat to the membrane 12f by means of a heating meander 32, which affects elasticity of the membrane, in another embodiment heat is applied by providing an infrared radiating source nearby membrane 12f or affecting elasticity by other radiation than heat radiation, e.g. by means of ultraviolet radiation.

These examples open to the skilled artisan a huge number of possibilities exploiting several known physical approaches to variably control the shape of a membrane in the acoustical channel 1, 1a as of FIG. 1 or 2 and/or to controllably vary elasticity of the material of such membrane and/or to variably affect the oscillating behaviour of such membrane.

Up to now all the specific embodiments described did not make use of the wall 1_{w} of the channel 1, 1a itself. The embodiments which now shall be described do make use of the wall 1_{w} itself as a converter member 9 as of FIG. 1 or of FIG. 2.

FIG. 15 most generically shows one embodiment of realizing member 9 of FIG. 1 or FIG. 2 by at least a part of the wall 1w of the channel 1, 1a.

According to FIG. 15 a section of the acoustical channel 1, 1a considered along its length extent, is made up by a membrane-like elastic structure. The open cross-sectional area 1ₒ may be varied by compressing or tensioning forces. So as to apply such forces, pneumatic or hydraulic drives may be used or piezoelectric drives or inductive drives.

Actuators based on the effect of electroactive polymers as discussed in Wikipedia “Electroactive Polymers” may be advantageously applied, e.g. products as manufactured by Micromuscle AB, Linköping, Sweden are most suited as will be shown.

According to FIG. 16 the acoustic channel 1 of FIG. 1 of the main transmission channel 1, 1a comprises a section 1b of elastic material. By means of a drive arrangement generically shown at 40 the length extent of the section 1b is controllably varied, thereby simultaneously reducing the open cross-section of the channel along section 1b.

In the embodiment according to FIG. 17 the section 1b of the channel 1, 1a is controllably compressed or released by compressing and releasing drive 42.

For the embodiments as shown in FIGS. 16 and 17 the controlled drive arrangements 40 provide the mechanical loading of section 1b of the acoustical channel 1, 1a and are respectively based on suited physical effects. Thus, the drive for the embodiment of FIG. 16 may e.g. be electromagnetic, pneumatic or hydraulic, whereas the drive for the embodiment of FIG. 17 may additionally be realized advantageously on the basis of electroactive polymer, especially by making use of an artificial muscle-type actuator.

FIGS. 18 and 19 show in a perspective and simplified representation an elastic section 1b of the channel 1, 1a which is, according to FIG. 18 and in analogy to the embodiment of FIG. 17, controllably compressed by means of an electroactive polymer artificial muscle actuator.

According to FIG. 19 by means of such artificial muscle actuator, a U-bent elastic section 1c of channel 1 is more or less bent.

With the help of the FIG. 3 to 19 we have discussed different embodiments by which sound pressure attenuation along an acoustical channel—including an acoustical “cavity”—of a hearing device may controllably be varied and especially and more specifically such attenuation along a main transmission channel especially of a hearing protection device.

Whereas we have discussed this technique according to the present invention departing from one aspect, namely needs in context with hearing protection devices at which sound pressure attenuation has to be controllably varied as e.g. for musicians, the addressed technique of sound pressure attenuation may—as was said—also be used and applied for hearing devices more generically, be it for attenuating sound pressure from sources in the surrounding of the user, be it for varying sound pressure attenuation in a venting channel, be it for such attenuation in another void space of the device which influences overall acoustical behaviour of the device.

In spite of the fact that different drive principles may be applied, as was explained electro-static, hydraulic, pneumatic, magnetic or inverse piezoelectric, it has been recognized that such drives may highly advantageously be construed on the basis of electroactive polymers, thereby more specifically on the basis of artificial muscles, especially when making use of the addressed acoustical channel itself as the member, shape, elasticity and/or oscillating behaviour thereof being controllably varied.

1. A hearing device or an attachment module to a hearing device comprising an acoustically effective channel, a member with at least one of controllably variable shape, of controllably variable elasticity, of controllably variable oscillating behaviour in the open space of said channel, sound pressure attenuation in said channel being directly controlled by said at least one of said shape, elasticity and behaviour.

2. The hearing device or module of claim 1 comprising a drive arrangement for controllably varying at least one of said shape, elasticity and oscillating behaviour, said drive arrangement comprising at least one of a piezoelectric drive, a pneumatic drive, a hydraulic drive, an electrostatic drive, a magnetic drive, an electroactive polymer drive.

3. The hearing device or module of claim 2, said drive arrangement comprising at least one electroactive polymer actuator of the artificial muscle type.

4. The hearing device or module of one of claims 1 to 3, said channel being an acoustic channel provided for leading sound pressure from the surrounding of a user towards user's ear drum or is a venting channel of said device or module.

5. The hearing device or module of claim 4 being a hearing protection device wherein said channel is provided for leading sound pressure from the surrounding of the user towards user's ear drum.

6. The hearing device or module of claim 5, said channel being conceived to be worn outside the ear of a user.

7. The hearing device or module of claim 5, said channel being conceived to be worn inside the ear of a user.

8. The hearing device or module of one of claims 1 to 7, said member comprising at least one membrane.

9. The hearing device or module of claim 8, said membrane being mounted across an open cross-sectional area of said channel.

10. The hearing device or module of one of claims 8 or 9, said membrane being controllably adjustable by controllably varying its tension.

11. The hearing device or module of one of claims 8 to 10, said membrane being controllably adjustable by controllably varying elasticity of the material of said membrane along at least a part of said membrane.

12. The hearing device or module of one of claims 8 to 12, said membrane being controllably adjustable by controllably varying the thickness thereof at least along a part of said membrane.

13. The hearing device or module of one of claims 1 to 12, said member comprising at least a part of the wall of said channel.

14. The hearing device or module of claim 13, said part being elastically stretchable, variation of the shape thereof comprising varying the length extent of said part.

15. The hearing device or module of one of claims 13 or 14, said part being elastically stretchable, variation of the shape thereof comprising varying the open cross-sectional area of said part.

16. The hearing device or module of one of claims 13 to 15 comprising an electroactive polymer actuator of the artificial muscle type to provide for said variation of shape of said part.

17. A method for varying acoustical attenuation of sound pressure in an acoustical effective void of a hearing device by controllably varying at least one of the shape, elasticity and oscillating behaviour of a member in said void.
